(19) United States
(12) Patent Application Publication
(10) Pub. No.: US 2026/0368529 A1
(43) Pub. Date: Nov. 19, 2026

(54) MULTIMODAL SPECULATIVE DECODING

(71) Applicant: Cerebras Systems Inc., Sunnyvale, CA (US)

(72) Inventors: Mugilan Ganesan, Sunnyvale, CA (US); Shane Segal, Sunnyvale, CA (US); Ankur Aggarwal, Sunnyvale, CA (US); Nishanth Sinnadurai, Sunnyvale, CA (US); Sean Lie, Los Altos, CA (US); Vithursan Thangarasa, Sunnyvale, CA (US)

(21) Appl. No.: 19/677,904

(22) Filed: May 14, 2026

Related U.S. Application Data
(60) Provisional application No. 63/806,227, filed on May 15, 2025.

(51) Int. Cl. G06N 3/088; G06N 3/045

(52) U.S. Cl. CPC G06N 3/088; G06N 3/045

(57) ABSTRACT

The present disclosure includes systems and methods for accelerating inference times, for example, based on multimodal speculative decoding techniques. A method includes receiving an input including first data of a first modality and second data of a second modality; generating a first one or more tokens associated with the first modality based on the second data; generating, using a second module, a second one or more tokens associated with the first modality based on the first data; generating one or more speculative tokens based on (a) the first one or more tokens associated with the first modality generated by the first module and (b) the second one or more tokens associated with the first modality generated by the second module; and performing speculative decoding inference based on the one or more speculative tokens.

### CROSS-REFERENCE TO RELATED APPLICATION

The present application claims priority to and the benefit of U.S. Provisional Patent Application No. 63/806,227, filed in the U.S. Patent and Trademark Office on May 15, 2025, which is hereby incorporated by reference in its entirety.

### TECHNICAL FIELD

The present disclosure relates to inference acceleration and model efficiency including speculative decoding.

### SUMMARY

Speculative decoding is a technique that may accelerate language model inference. In speculative decoding, a lightweight draft model may generate speculative tokens, and a larger target model may verify the generated speculative tokens. In some approaches, a large target model may perform autoregressive token generation such that a target model performs a full forward pass to generate a single token. Speculative decoding may accelerate inference by generating speculative tokens with the lightweight draft model, reducing the number of full passes by the larger target model, and leveraging parallel verification capabilities of language models. However, extending speculative decoding to multimodal language models (e.g., vision language models) may be challenging due to architectural incompatibility and/or distribution mismatch.

In some approaches, a draft model and a target model are of the same modality. For example, both a draft and target model may be text-to-text models. As such, because both models process data of the same modality, a draft model may generate data that is of an operable dimensionality for a target model. Several challenges arise when applying speculative decoding techniques to multimodal workflows as unimodal draft models cannot effectively capture the visual nature of a target visual language model.

In some approaches, a multimodal draft model may be used to generate speculative tokens for a multimodal target model. In such approaches, however, a multimodal draft model may not achieve substantial inference speed ups if autoregressive generation is also computationally expensive. For example, because multimodal models are typically more architecturally complex than unimodal models (e.g., text-to-text models), even small draft multimodal models may introduce similar computational bottlenecks as using a single large target multimodal model.

Furthermore, distribution mismatches continue to introduce challenges in fully leveraging speed ups achieved through speculative decoding. For example, even in text-to-text draft and target models, a draft model may utilize a distribution that does not fully capture a distribution of a target model. Mismatches in distributions may result in lower token acceptance rates, thereby diminishing returns and decreasing speedups by speculative decoding techniques.

To address the above-discussed issues and more, the present disclosure describes some embodiments that provide systems, methods, apparatuses, and/or non-transitory computer readable media including a speculative decoding framework. In some embodiments, the framework may include one or more of: multimodal speculative decoding, vocabulary expansion, self-data distillation that increases token acceptance rates, or reasoning-aware adaptations. Accordingly, the present disclosure provides some embodiments that provide various improvements upon previous approaches. In some embodiments, inference may be accelerated by applying speculative decoding techniques to multimodal target models while maintaining the computational simplicity and efficiency of non-multimodal draft models. In some embodiments, inference may be accelerated by increasing token acceptance rates based on applying self-data distillation techniques during training of at least one of a projector or a draft model. In some embodiments, draft models may be able to generate speculative reasoning tokens based on vocabulary expansion, thereby further expanding speculative decoding techniques to non-reasoning frameworks.

In some embodiments, a method may include: receiving an input comprising first data of a first modality and second data of a second modality; generating, using a first module, a first one or more tokens associated with the first modality based on the second data, where the first module is trained to map embeddings of the second modality to embeddings of the first modality; generating, using a second module, a second one or more tokens associated with the first modality based on the first data; generating, using a third module, one or more speculative tokens based on (a) the first one or more tokens associated with the first modality generated by the first module and (b) the second one or more tokens associated with the first modality generated by the second module; and performing, using a fourth module, speculative decoding inference based on the one or more speculative tokens.

In some embodiments, the first modality includes a text type; and the second modality includes an image type.

In some embodiments, the first module includes a multimodal projector; the second module includes a text tokenizer; the third module includes a draft model associated with a first number of parameters; and the fourth module includes a target model associated with a second number of parameters that is greater than the first number of parameters.

In some embodiments, the draft model includes a text-to-text model; and the target model includes a multimodal model.

In some embodiments, the fourth module, for a plurality of multimodal inputs, generates a plurality of respective outputs of the first modality; each of the plurality of multimodal inputs includes a respective first input of the first modality and a respective second input of the second modality; and the third module is trained to generate tokens of the first modality based on the plurality of respective outputs generated by the fourth module.

In some embodiments, the third module is associated with a first vocabulary; the fourth module is associated with a second vocabulary; and the third module is trained based at least in part on an unmatched vocabulary representing a difference between the second vocabulary and the first vocabulary.

In some embodiments, a fifth module determines an unmatched vocabulary representing a difference between a first vocabulary of the third module and a second vocabulary of the fourth module; the fifth module determines embeddings for the unmatched vocabulary based on a mean of an existing vocabulary and a covariance of the existing vocabulary; and the third module generates the one or more speculative tokens based at least in part on the embeddings.

In some embodiments, the one or more speculative tokens include reasoning tokens and non-reasoning tokens.

In some embodiments, the first module is trained based on constant parameters of a fifth module and constant parameters of the third module, where the fifth module includes a target vision encoder and the third module includes a draft model for the fourth module.

In some embodiments, performing the speculative decoding inference includes verifying, using the fourth module, the one or more speculative tokens generated by the third module.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1 is a block diagram illustrating multimodal speculative decoding, in accordance with one or more embodiments of the present disclosure;

FIG. 2 is a block diagram showing a training procedure for a multimodal projector, in accordance with some embodiments of the present disclosure;

FIG. 3 is a block diagram showing how a distribution of a draft model may be aligned with a distribution of a target model, in accordance with some embodiments of the present disclosure;

FIG. 4 is a flowchart of an example process for reducing divergence between a draft distribution and target distribution, in accordance with some embodiments of the present disclosure;

FIG. 5 is a flowchart of an example process for vocabulary expansion, in accordance with some embodiments of the present disclosure;

FIGS. 6A-6C are flowcharts of example processes for performing speculative decoding using vocabulary expansion, in accordance with some embodiments of the present disclosure;

FIG. 7 is a flowchart of an example process for performing speculative decoding with multimodal data, in accordance with some embodiments of the present disclosure;

FIG. 8 shows a block diagram illustrating an example compute accelerator, in accordance with some embodiments of the present disclosure;

FIG. 9 depicts an example layout including placement of processing regions at a compute accelerator and routing therebetween, in accordance with some embodiments of the present disclosure;

FIG. 10 shows a block diagram illustrating an example processing element (PE) of a compute accelerator, in accordance with some embodiments of the present disclosure; and

FIGS. 11-12 are illustrative examples of practical results that may be achieved based on some embodiments disclosed herein, in accordance with some embodiments of the present disclosure.

### DETAILED DESCRIPTION

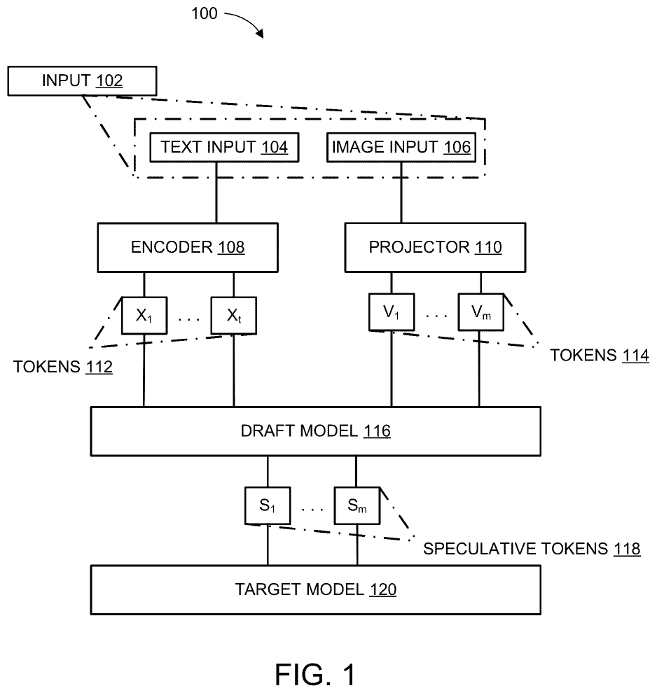

FIG. 1 is a block diagram illustrating multimodal speculative decoding, in accordance with one or more embodiments of the present disclosure. In order to maintain a certain level of latency during inference, a unimodal model (e.g., a text-only model) may be used as a draft model for a multimodal target model. In some embodiments, a multimodal projector may be used in order to maintain usage of unimodal draft models in multimodal speculative decoding frameworks. Such embodiments may improve upon previous approaches, for example, in ways related to at least one of inference speed up or acceptance length.

Although FIG. 1 illustrates undirected connections between components (e.g., representing bidirectionality), it will be understood that one or more of such connections may represent unidirectional connections. For example, in FIG. 1, some connections may include arrow heads facing downwards with respect to a readable orientation of the drawing. As such, for example, text input 104 may be illustrated as being used as input for encoder 108.

Arrangement 100 includes use of the following components: encoder 108, projector 110, draft model 116, and target model 120. It will be understood that each of the aforementioned components are merely illustrative, and any suitable module may be used to provide respective functionalities. For example, a single module may be used to implement the functionality of both encoder 108, projector 110, and draft model 116. As such, the discretization of components, as shown in FIG. 1 is merely one example. Further description of the use of such components is provided below.

In some embodiments, input 102 may be a multimodal input. In some embodiments, input 102 may include text input 104 and image input 106. It will be understood that input 104 being a text input and input 106 being an image input is merely exemplary. For example, inputs 104 and 106 may be inputs of different modalities. In an example, input 104 may correspond to inputs of audio modality and input 106 may correspond to inputs of video modality. For the purposes of illustration, it may be assumed that text input 104 includes input of a text modality (e.g., a caption), and image input 106 includes input of an image modality (e.g., one or more images).

In some embodiments, encoder 108 and projector 110 may each generate embeddings of a modality that draft model 116 may suitably use as input. For example, draft model 116 may be a text-only model that accepts text data as input and generates text data as output. As such, in some embodiments, encoder 108 may generate tokens 112, and projector 110 may generate tokens 114. In some embodiments, tokens 112 and 114 may be of a joint embedding space, where draft model 116 may use input that is of such a joint embedding space. For example, if draft model 116 is a text-only model, then tokens 112 and 114 may each be of a text embedding space.

In some embodiments, draft model 116 may generate speculative tokens 118 based on tokens 112 and 114. In some embodiments, target model 120 may perform inference based on speculative tokens 118. For example, target model 120 may verify speculative tokens 118 (e.g., as part of a speculative decoding framework). It will be understood that target model 120 may be a multimodal model capable of processing both text embeddings and image embeddings, but draft model 116 generates speculative tokens 118 to speed up inference compared to if target model 120 performed autoregressive inference on all tokens for a given input. The way in which projector 110 is trained may be non-trivial and is further described below.

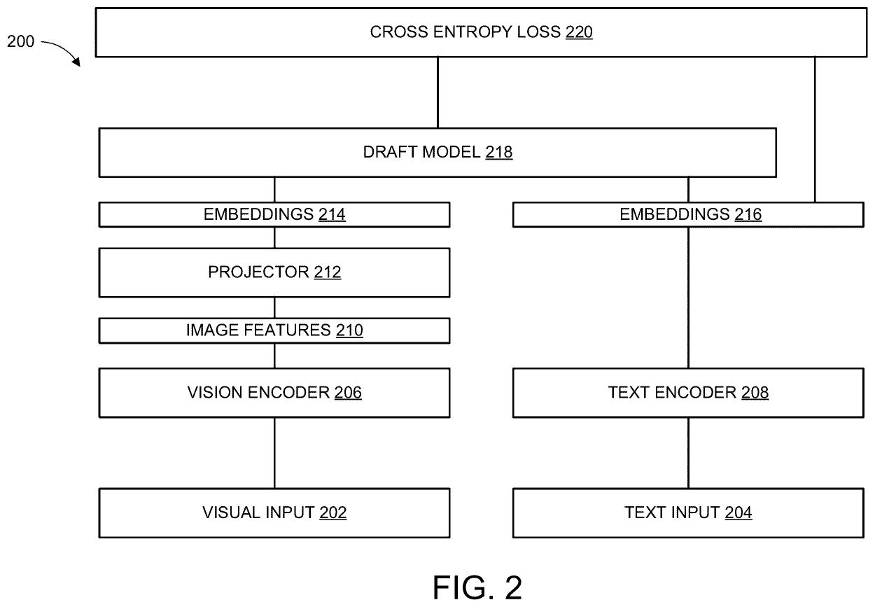

FIG. 2 is a block diagram showing a training procedure for a multimodal projector, in accordance with some embodiments of the present disclosure. Multimodal drafting may be thought of as mapping between an embedding space of a target multimodal model to an embedding space of a draft model (e.g., where such a draft model is a unimodal model). As such, a projector may be used to provide inputs that are typically of a different embedding space than the embedding space used by a draft model for processing.

As previously described in connection to FIG. 1, although FIG. 2 illustrates undirected connections between components (e.g., representing bidirectionality), it will be understood that one or more of such connections may represent unidirectional connections. For example, in FIG. 2, some connections may include arrow heads facing upwards with respect to a readable orientation of the drawing. As such, for example, text input 204 may be illustrated as being used as input for text encoder 208.

In some embodiments, arrangement 200 provides an example workflow for how such a projector may be trained. Furthermore, it will be understood that although certain components are labeled differently between FIGS. 1 and 2, some components may correspond to the same component (e.g., but at different points in time). For example, FIG. 1 may describe components during inference whereas FIG. 2 may describe components during training. In some embodiments, encoder 208 may correspond to encoder 108, projector 212 may correspond to projector 110, and draft model 218 may correspond to draft model 116.

In some embodiments, a multimodal input may include visual input 202 and text input 204. It will be understood that inputs 202 and 204 may be of any suitable modality but are described as being of visual and text modalities, respectively, merely for the purpose of illustration. In some embodiments, inputs 202 and 204 may be handled separately, as further described below.

In some embodiments, text encoder 208 may determine embeddings 216 based on text input 204. In some embodiments, draft model 218 may accept embeddings that are of the same space as embeddings 216. While only text encoder 208 is illustrated in FIG. 2, it will be understood that processing steps other than encoding may occur. For example, text input 204 may be tokenized by a tokenizer, and such tokenized data may be sent into text encoder 208.

In some embodiments, vision encoder 206 may correspond to a vision encoder used by a target model (e.g., a vision encoder of target model 120). In some embodiments, vision encoder 206 may determine image features 210 based on visual input 202. Image features 210, for example, may include embeddings of a visual modality. Such embeddings may represent visual information including edges, textures, colors, shapes, spatial relationships, semantic concepts, or any other suitable type of information that may be determined from a visual input.

In some embodiments, projector 212 may generate embeddings 214. Embeddings 214 may be of the same embedding space as embeddings 216. As such, draft model 218 may perform operations on both embeddings 214 and embeddings 216. For example, if draft model 218 is a text generation model that only accepts inputs of text modality, then embeddings 214 and embeddings 216 may both be text embeddings.

In some embodiments, in order to train projector 212, parameters of draft model 218 and vision encoder 206 may be kept constant. In some embodiments, for some training set

$$D = {\{ ( {I}_{j} , {C}_{j} ) \}}_{j = 1}^{N}$$

of N many image-text captions (e.g., where Iⱼ represents visual data and Cⱼ represents text data), projector 212 may be trained such that the following is optimized:

$$L ( ψ ) = - {\sum }_{j = 1}^{N} {\sum }_{i = 1}^{\vert {C}_{j} \vert} log {q}_{ψ} ( {c}_{j}^{i} \vert {c}_{j}^{1 : i - 1} , {V}_{j} )$$

where Vⱼ corresponds to one or more projected features determined by projector 212 at a given training instance,

$${c}_{j}^{i}$$

corresponds to an i-th token of some caption Cⱼ, and q_{ψ}, corresponds to a distribution of draft model 218 with projector parameters ψ. As such, during the training of projector 212, only projector parameters ψ may be updated while parameters associated with vision encoder 206 and draft model 218 remain constant.

In some embodiments, cross entropy loss 220 may be used during training of projector 212. It will be understood that any suitable loss metric may be used during training of projector 212. For example, mean squared error (MSE), root mean squared error (RMSE), or perceptual loss may be used instead or in addition to cross entropy loss 220.

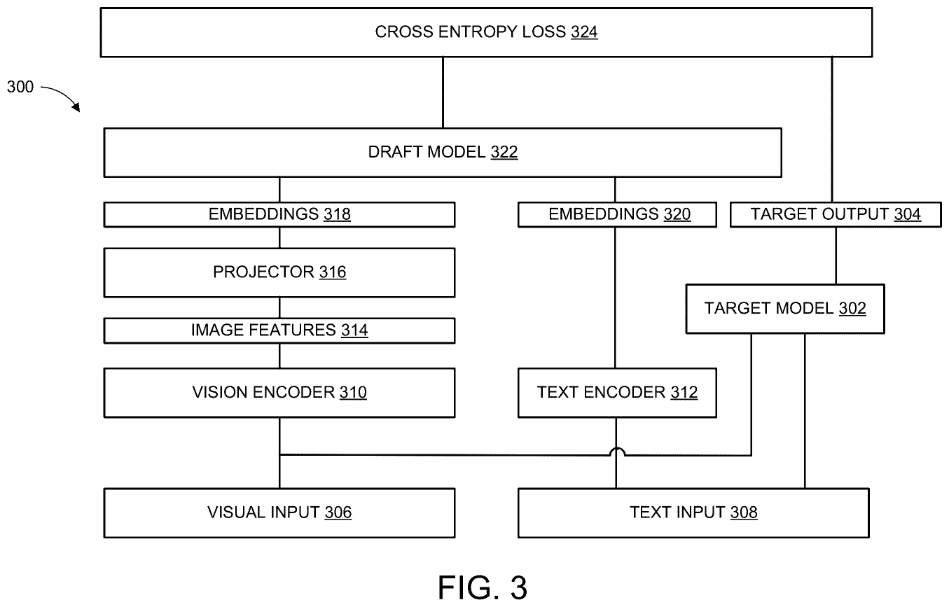

FIG. 3 is a block diagram showing how a distribution of a draft model may be aligned with a distribution of a target model, in accordance with some embodiments of the present disclosure. In some embodiments, diagram 300 depicts a self-distilled visual instruction tuning (SDViT) approach that employs self-data distillation (SDD) to align a distribution of a draft model to a distribution of a target model, such that a distribution of a target model corresponds to a multimodal distribution. In some embodiments, it may be desirable to align tokens generated by draft model with tokens generated by target model 302. As such, outputs generated by target model 302 may be used as reference for which draft model 332 is tested against.

Furthermore, it will be understood that one or more components of arrangement 300 may correspond to one or more components of FIGS. 1 and 2. In some embodiments, vision encoder 310 may correspond to vision encoder 206, text encoder 312 may correspond to at least one of encoder 108 or 208, projector 316 may correspond to at least one of projector 110 or 212, draft model 322 may correspond to at least one of draft model 116 or 218, and target model 302 may correspond to target model 120.

As previously described in connection to FIG. 2, although FIG. 3 illustrates undirected connections between components (e.g., representing bidirectionality), it will be understood that one or more of such connections may represent unidirectional connections. For example, in FIG. 3, some connections may include arrow heads facing upwards with respect to a readable orientation of the drawing. As such, for example, text input 308 may be illustrated as being used as input for text encoder 312.

In some embodiments, target model 302 may generate target output 304 based on visual input 306 and text input 308. In some embodiments, target output 304 may form a self-distilled dataset. As such, training draft model 322 may result in a higher token acceptance rate during speculative decoding because, for example, an output distribution of draft model 322 will be similar to that of an output distribution of target model 302. A token acceptance rate may refer to the number, percentage, or quantity indicating how many tokens a target model accepts from a draft model. An increased acceptance rate generally leads to speed ups and lower latency during inference.

In some embodiments, target model 302 may generate a plurality of responses based on different temperature values and/or with various top-p sampling parameters to generate a more varied dataset (e.g., in comparison to fixed datasets used for testing). In some embodiments, training draft model 322 based at least in part on target output 304 may result in attenuated differences or otherwise increased similarity between a draft distribution and a target distribution (e.g., in comparison to fixed testing data sets), and therefore also result in increased token acceptance rates. Furthermore, training draft model 322 based on target output 304 may be particularly advantageous for multimodal inputs. For example, acceptance rates for tokens that represent visual data with draft models that output text tokens may be further increased (e.g., in comparison to fixed dataset approaches where a draft model and target model are tested on the same fixed dataset).

In some embodiments, during training of draft model 322 and projector 316, parameters associated with vision encoder 310 and target model 302 may remain constant. As such, draft model 322 and projector 316 may be trained while intended outputs of target model 302 also remain the same. Furthermore, it will be understood that at least some aspects of arrangement 200 may be applied to workflow 300. For example, vision encoder 310 may generate image features 314 based on visual input 306, and projector 316 may generate embeddings 318 based on image features 314. In another example, text encoder 312 may generate embeddings 320 based on text input 308. In a further example, cross entropy loss 324, or any suitable loss function, may be used to evaluate responses generated by draft model 322 (e.g., at least in comparison to target output 304).

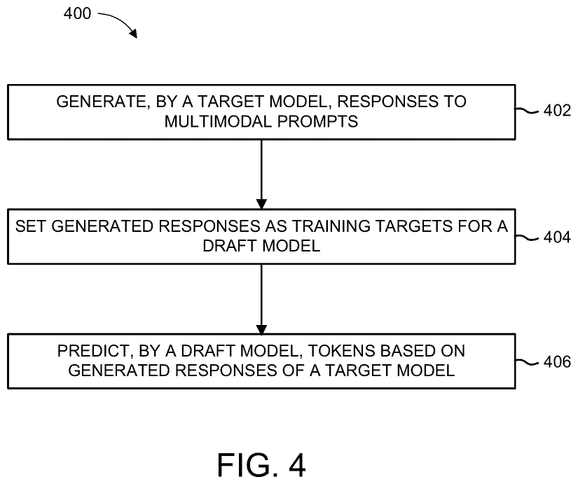

FIG. 4 is a flowchart of an example process for reducing divergence between a draft distribution and target distribution, in accordance with some embodiments of the present disclosure. In some embodiments, process 400 may be a self-distillation strategy that optimizes or otherwise increases token acceptance rates. That is, process 400 may be employed to increase the number of tokens that a target model accepts, where such tokens are generated by a draft model (e.g., in comparison to generic knowledge distillation with fixed dataset labels). Furthermore, in some embodiments, process 400 may include at least steps 402-406. It will be understood that process 400 may be implemented using one or more components such as those described at any of FIGS. 1-3.

In some embodiments, at step 402, a target model may generate one or more responses to a multimodal prompt. A target model may correspond to target model 302, and one or more responses to a multimodal prompt may correspond to target output 304. In some embodiments, a target model may generate such responses before, during, or concurrently with the training of a draft model.

In some embodiments, at step 404, a draft model may use responses generated by a target model as training targets. For example, target output 304 may be used as a testing dataset for draft model 218. It will be understood that projector 212 may be trained concurrently with draft model 218.

In some embodiments, at step 406, a draft model may predict tokens based on generated responses of a target model. For example, as previously described in connection with FIG. 3, cross entropy 220, or any other suitable loss metric, may be calculated with respect to tokens generated by draft model 218 and target output 304 generated by target model 302.

To further enhance multimodal speculative decoding, in some embodiments, one or more operations related to vocabulary expansion may be performed. For example, in some approaches, draft models and target models may employ different tokenizers, thereby resulting in vocabulary mismatches that may reduce the effectiveness of speculative decoding frameworks. Furthermore, even with compatible tokenizers, independently training models may result in distributions that are sufficiently different enough such that token acceptance rate are lowered and practical speed ups achieved by way of speculative decoding are diminished. Effects of a draft model and target model having sufficiently different distributions may be further compounded if a target model is multimodal and a draft model is not multimodal.

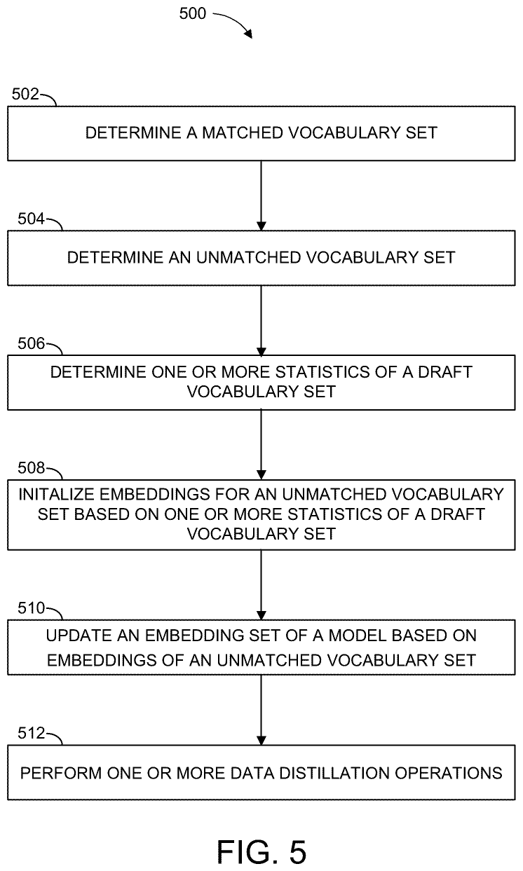

FIG. 5 is a flowchart of an example process for vocabulary expansion, in accordance with some embodiments of the present disclosure. In some embodiments, a vocabulary may refer to a look up table that maps between tokens and identifiers. An identifier, for example, may be an integer used to determine one or more corresponding embeddings for a given token. Different models may be associated with different vocabularies. For example, draft model 218 may use a draft vocabulary set, whereas target model 302 may use a target vocabulary set that is more expansive than a draft vocabulary set. A vocabulary set may refer to the complete set of tokens for which there exists associated identifiers.

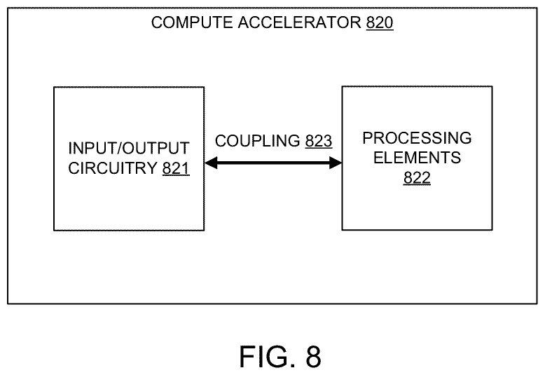

Process 500, as further described below, provides a way to expand a vocabulary associated with a model (e.g., a draft model). That is, process 500 provides a vocabulary expansion process for a model. It will be understood that one or more steps of process 500 may be implemented by any circuitry provided herein (e.g., any hardware and/or firmware as further described in connection with FIGS. 8-10).

In some embodiments, process 500, along with other processes described herein (e.g., process 700 as further described below), is described as being implemented by processing circuitry. It will be understood that processing circuitry may include any suitable hardware, firmware, software, or combinations thereof that may implement any of the functionality described in the present disclosure. In some embodiments, processing circuitry may include any one or more of the following: application specific integrated circuits (ASICs), field-programmable gate arrays (FPGAs), central processing units (CPUs), graphics processing units (GPUs), tensor processing units (TPUs), neural processing units (NPUs), signal processors, microcontrollers, network on chip (NOC) components, interconnections, fabrics, virtualization layers, memory devices, programmable logic devices, or combinations thereof. In some embodiments, processing circuitry may include any hardware, firmware, or software as further described below in connection with FIGS. 8-10. For example, processing circuitry may include at least one of deep learning accelerator 820, compute accelerator 900, or PE 1000. In some embodiments, process 500, along with other processes described herein (e.g., process 700 as further described below), may be implemented by one device or distributed among multiple devices.

In some embodiments, at step 502, processing circuitry may determine a matched vocabulary set. For example, processing circuitry may determine a vocabulary associated with a target model, determine a vocabulary associated with a draft model, and then determine an intersection between the two aforementioned vocabularies. Such an intersection may correspond to a matched vocabulary set.

In some embodiments, at step 504, processing circuitry may determine an unmatched vocabulary set. For example, processing circuitry may determine a vocabulary associated with a target model, determine a vocabulary associated with a draft model, and then determine a set difference between the two aforementioned vocabularies. Such a set difference may correspond to a matched vocabulary set. In some embodiments, an unmatched vocabulary set may be determined based on string representations. For example, an unmatched vocabulary set may include each target identifier associated with a target vocabulary such that there does not exist a draft identifier associated with a draft vocabulary where applying a decoding function the target identifier and the draft identifier would result in the same string.

In some embodiments, at step 506, processing circuitry may determine one or more statistics of a draft vocabulary set. For example, processing circuitry may determine a mean associated with a draft vocabulary set and a covariance associated with a draft vocabulary set. In some embodiments, determining a mean associated with a draft vocabulary set may include determining an average of embeddings associated with a draft vocabulary set. In some embodiments, similarly, determining a covariance associated with a draft vocabulary set may include determining a covariance matrix for embeddings associated with a draft vocabulary set.

In some embodiments, at step 508, processing circuitry may initialize embeddings for each token of an unmatched vocabulary based on one or more statistics of a draft vocabulary set. In some embodiments, an embedding for a token may be initialized based on a mean determined at step 506 and a sample based on a normal distribution centered around zero with a covariance determined at step 506. As such, for example, each embedding for each token of an unmatched vocabulary may be determined as follows: add a respective epsilon to each embedding associated with each token of a draft vocabulary, where each respective epsilon is based on a random variable which follows from a normal distribution centered around 0 with a covariance determined at step 506; take a sum of all embeddings plus a respective epsilon; and divide the sum by the cardinality of the draft vocabulary set. It will be understood that one or more other statistics may be used instead of or in addition to the aforementioned example for determining embeddings for an unmatched vocabulary. Furthermore, it may be desirable to initialize embeddings based on one or more statistics associated with a draft vocabulary to minimize, lessen, mitigate, or otherwise reduce a divergence (e.g., a Kullback-Leibler (KL) divergence) between a distribution associated with a draft model and a distribution associated with a target model.

In some embodiments, at step 510, processing circuitry may update an embedding set of a model based on embeddings of an unmatched vocabulary set (e.g., as previously determined at step 508). As such, a draft model vocabulary may be more similar a target model vocabulary, thereby reducing a KL divergence between a draft distribution and a target distribution.

In some embodiments, at step 512, processing circuitry may perform one or more self-data distillation operations to further align a draft distribution to a target distribution. For example, a target model may generate one or more responses (e.g., based on a target tokenizer), and an expanded draft model vocabulary may be further tuned based on generated responses of a target model.

In some embodiments, one or more aspects of process 500 may be applied to other types of tokens. Such other types of tokens may include, for example, reasoning tokens, beginning-of-sequence (BOS) tokens, end-of-sequence (EOS) tokens, padding tokens, or any suitable type of token that serves an architectural function. In some embodiments, processing circuitry may determine identical symbolic representations for such tokens between both draft models and target models.

In some embodiments, vocabulary expansion may be applied to reasoning tokens. Processing circuitry, in some embodiments, may determine reasoning tokens where a target vocabulary already includes identifier-string representations, but a draft target vocabulary does not already include corresponding identifier-string representations. In some embodiments, determining an unmatched vocabulary set (e.g., as in step 504), may include determining reasoning tokens for which there does not exist a mapping with a draft vocabulary. As such, processing circuitry may expand a vocabulary of a draft model to include reasoning tokens for which there does not exist a mapping based on a draft vocabulary. Similar to step 508, embeddings for such reasoning tokens may be determined based on one or more statistics of a draft vocabulary.

In some embodiments, processing circuitry may apply self-distillation operations (e.g., include at least some operations previously described in connection with step 512) to unmatched reasoning tokens. For example, a target model may generate structured outputs based on at least one of chain-of-thought decomposition, intermediate calculation steps, logical justifications, self-verification, error correction, or any other operation associated with reasoning. In some embodiments, accordingly, a draft model may be trained at least in part on a distilled reasoning set that includes one or more reasoning outputs of a target model. As such, a draft model may be suited to determine at least one of the following: when to generate reasoning tokens over non-reasoning tokens (and vice versa), organization for multi-step reasoning traces, or how to otherwise behave similarly to a reasoning approach of a target model. It will be understood that while the aforementioned embodiments are directed towards reasoning tokens, such principles may also be applied to other architectural tokens (e.g., BOS tokens, EOS tokens, or the like).

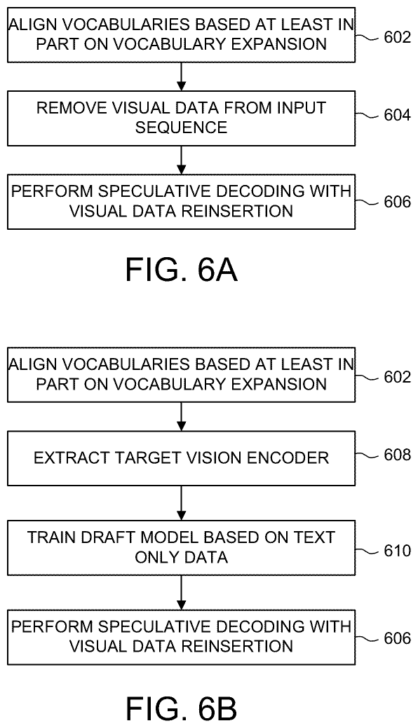

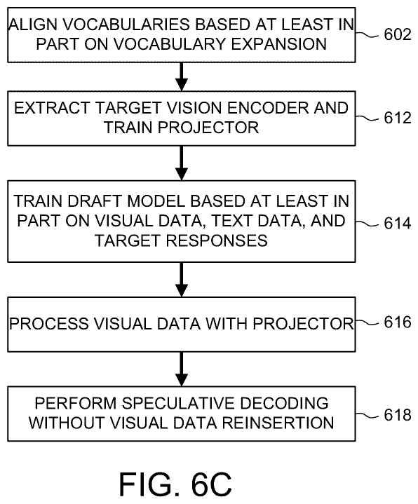

It will be understood that vocabulary expansion (e.g., as previously described in connection with FIG. 5) may be applied to other speculative decoding frameworks. For example, as further described below in connection with FIGS. 6A-6C, vocabulary expansion may be applied to multimodal frameworks.

FIGS. 6A-6C are flowcharts of example processes for performing speculative decoding using vocabulary expansion, in accordance with some embodiments of the present disclosure. While the processes of each of FIGS. 6A-6C are shown separately, one or more steps may be combined, modified, or otherwise included with one or more steps of other processes. As such, each of the processes of FIGS. 6A-6C may be thought of as different embodiments which apply similar techniques. In some embodiments, any of the processes described in FIGS. 6A-6C may be used to reduce a KL-divergence between a draft distribution and a target distribution. Furthermore, it will be understood that one or more steps of the processes of FIGS. 6A-6C may be implemented by processing circuitry (e.g., any hardware and/or firmware as further described in connection with FIGS. 8-10).

In some embodiments, FIG. 6A illustrates a process that may include using a text-only draft model with image token exclusion and reinsertion. It may be desirable to do so, for example, in cases where additional training of a draft model is foregone (e.g., in cases where existing text-only models are used for speculative decoding without further training). In some embodiments, at step 602, processing circuitry may perform one or more vocabulary expansion operations with respect to a draft model and a target model. In some embodiments, step 602 may include one or more operations of process 500. As such, processing circuitry may perform one or more operations related to lessening the KL divergence between a draft distribution and a target distribution. In some embodiments, at step 604, processing circuitry may exclude visual data (e.g., image tokens) before passing an input to a text-only draft model. Accordingly, a draft model may be trained without accounting for having to process image tokens or text tokens that are based on image tokens. In some embodiments, at step 606, processing circuitry may proceed to perform speculative decoding with visual data reinsertion. Step 606 may occur during inference. For example, step 606 may include one or more of the following operations: removing visual data from an input sequence (e.g., where an input sequence includes both text data and visual data such as text input 104 and image input 106); generating speculative tokens (e.g., by way of a draft model); verifying generated speculative tokens (e.g., by way of a target model); and reinserting image tokens at original positions (e.g., such that a target model continues processing based on image tokens and verified speculative tokens).

In some embodiments, FIG. 6B illustrates a process that may include a text-only adaptation via self-data distillation. As such, multimodal knowledge may be transferred to a draft model (e.g., a text-only draft model) through self-data distillation. In some embodiments, processing circuitry may perform step 602 (e.g., as previously described above in connection with FIG. 6A). In some embodiments, at step 608, processing circuitry may utilize a vision encoder of a target model. In some embodiments, at step 610, processing circuitry may cause a draft model to be trained on text-only data. For example, a target model may generate responses based on both image and text data, and a draft model may be trained based on responses generated by a target model. As such, a draft model is trained to attain results generated by a target model, where such results generated by a target model are generated based on multimodal inputs. Additionally, a draft model may be implicitly trained to generate responses that account for visual information that may be present in a multimodal input, even if a draft model itself does not receive such visual information directly. A draft model may learn to recognize patterns in text prompts that may indicate presence of visual content and thereby generate responses based on how a target model may typically respond to such content. Accordingly, because a draft model is not trained based on image data, image tokens may still be reinserted into their original positions during inference. In some embodiments, therefore, at step 606, processing circuitry may perform speculative decoding with visual data reinsertion (e.g., as previously described above in connection with FIG. 6).

In some embodiments, FIG. 6C illustrates a process which includes a multimodal projector adaptation. In some embodiments, processing circuitry may perform step 602 (e.g., as previously described in connection with FIG. 6A). In some embodiments, at step 612, processing circuitry may extract a target vision encoder (e.g., encoder 108) and cause a projector (e.g., projector 110) to be trained. In some embodiments, a projector may be trained based at least in part on description provided in connection with FIG. 2. For example, a projector may be trained such that parameters of an encoder and parameters of a draft model are kept constant. That is, a projector may be trained independently from both an encoder and a draft model. Similar to FIGS. 1-3, because a projector may be coupled to a draft model, a unimodal draft model (e.g., a text-only draft model) may effectively function as a multimodal draft model because a projector may convert visual inputs into embeddings that a draft model is able to process. In some embodiments, at step 614, processing circuitry may train a draft model based at least in part on visual data, text data, and target responses. For example, a draft model may generate speculative tokens of text type, but such a draft model may be trained on a testing set such that a testing set is generated by a target model that handles multimodal inputs. In some embodiments, at step 614, processing circuitry may jointly train a draft model and projector while keeping parameters associated with a target vision encoder constant. Joint training may align predictions of a unimodal draft model with responses of a multimodal target model, thereby providing practical speed ups for multimodal speculative decoding frameworks (e.g., compared to previous approaches).

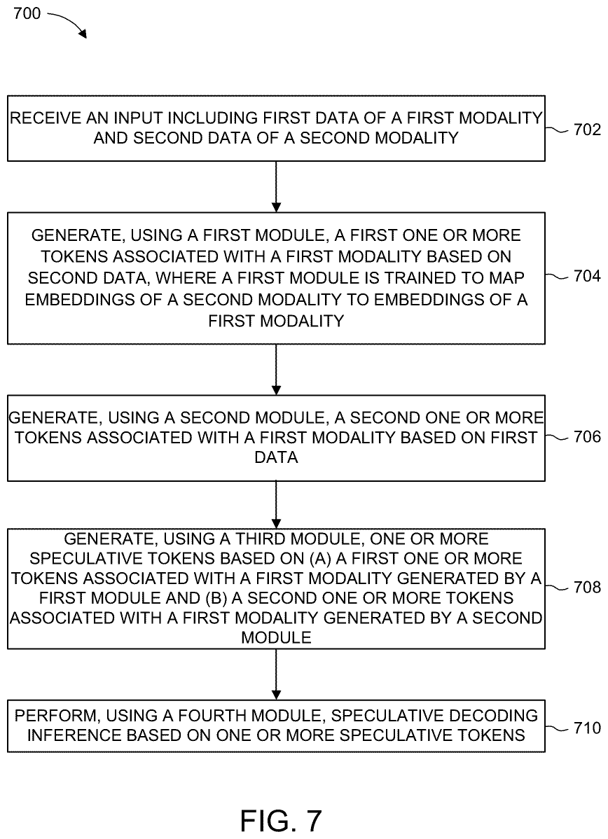

In some embodiments, inference operations may forego reinsertion of visual data into original positions after a target model performs verification. In some embodiments, at step 616, processing circuitry may process visual data with a projector (e.g., where such visual data is part of a multimodal input). In some embodiments, at step 618, processing circuitry may cause a draft model to generate speculative tokens based on tokens processed by a projector and tokens associated with a modality the draft model is configured to process. As such, a target model may perform verification on speculative tokens generated by a draft model without having to re-account for visual data that is reinserted into respective original positions. FIG. 7 provides further detail on how a projector may be used so that a unimodal draft model may generate speculative tokens based on multimodal inputs.

FIG. 7 is a flowchart of an example process for performing speculative decoding with multimodal data, in accordance with some embodiments of the present disclosure. Process 700 may be implemented by any suitable circuitry such as processing circuitry (e.g., where processing circuitry may include any circuitry as described below in connection to FIGS. 8-10). For example, process 700 may be implemented by any other suitable circuitry described herein. While reference may be made in the following paragraphs to specific components (e.g., any of FIGS. 1-3), it is understood that any suitable component may be included without departing from the principles set forth in the present disclosure.

It will be understood that steps 702-710 may occur in parallel or in any suitable order. For example, steps 702 and 704 may begin at the same time. As such, the order in which steps 702-710 are illustrated in FIG. 7 is meant to be illustrative and not meant to be limiting.

It will be understood that referenced to modules below is meant to merely be illustrative and not meant to be limiting. For example, while the description below includes references to a first module, a second module, a third module, and a fourth module, it will be understood that each of the aforementioned modules may be implemented as a single module, or any suitable combination of modules may be used to provide such functionality. For example, one module may provide the functionality of a first and second module, while another module may provide the functionality of a third and fourth module, as further described below. Additionally, it will be understood that processing circuitry, as referred to herein, may implement the functionality provided by any of a first module, a second module, a third module, or a fourth module.

In some embodiments, at step 702, processing circuitry may receive an input including first data of a first modality and second data of a second modality. In some embodiments, a first modality and second modality may be different modalities. For example, a first modality may include a text modality, and a second modality may include an image or non-text modality. For example, referring to FIG. 1, first data of a first modality may correspond to text input 104, and second data of a second modality may correspond to image input 106.

In some embodiments, at step 704, processing circuitry may generate, using a first module, a first one or more tokens associated with a first modality based on second data, where a first module is trained to map embeddings of a second modality to embeddings of a first modality. A first module may generate embeddings that are suitable inputs for draft model 116. For example, if draft model 116 is a text-only model, then projector 110 may generate text embeddings or any other type of embedding of some dimensionality which draft model 116 accepts as input.

In some embodiments, a first module may be any module that handles processing of visual data and generates data that may be used as input for a third module (e.g., where a third module includes draft model 116). In some embodiments, a first module may include one or both of a projector and a visual encoder. For example, a vision encoder may receive image input 106 and determine one or more visual embeddings based on such received input. Projector 110 may utilize visual embeddings generated by a vision encoder as input. That is, projector 110 may take input data of a first dimensionality and output data of a second dimensionality, such that a first dimensionality corresponds to a visual embedding space, and a second dimensionality corresponds to a text embedding space.

In some embodiments, at step 706, processing circuitry may generate, using a second module, a second one or more tokens associated with a first modality based on first data. A second module may generate embeddings that may be processed by a draft model. For example, a second module may correspond to encoder 108, and a second or more tokens may correspond to tokens 112. In some embodiments, a second module may generate embeddings that are of the same modality as embeddings generated by a first module, such that embeddings generated by a first module may be used as input for a draft model. As such, a first and second module may each generate embeddings of a modality suitable for input into a draft model.

It will be understood that generating tokens associated with a first modality based on first data may be implemented by a draft model, and use of a second module is merely illustrative. For example, in some embodiments, text input 104 may be used as input into draft model 116. As such, draft model 116 may be based on a tokenizer-free architecture.

In some embodiments, at step 708, processing circuitry may generate, using a third module, one or more speculative tokens based on (a) a first one or more tokens associated with a first modality generated by a first module and (b) a second one or more tokens associated with a first modality generated by a second module. In some embodiments, a third module may include any module that generates speculative tokens that a fourth module may verify (e.g., where a fourth module includes a target model). In some embodiments, a third module may correspond to draft model 116. In some embodiments, a third module may generate speculative tokens based on embeddings generated by a first and second module, where such embeddings may be representations of a multimodal input. In some embodiments, one or more speculative tokens may include speculative tokens 118.

In some embodiments, at step 710, processing circuitry may perform, using a fourth module, speculative decoding inference based on one or more speculative tokens. In some embodiments, a fourth module may correspond to a target model (e.g., target model 120).

In some embodiments, a first modality may include a text type, and a second modality may include an image type. For example, text input 104 may be considered data of a first modality, and image input 106 may be considered data of a second modality. It will be understood that a first and second modality may each correspond to any suitably different modalities. For example, a first modality may include audio data, and a second modality may include textual data. As such, while the present disclosure primarily discusses textual and visual data as the different modalities, any other suitably different modalities may be used while still being in accordance with some embodiments disclosed herein.

In some embodiments, a first module includes a multimodal projector (e.g., projector 110), a second module includes a text tokenizer, a third module includes a draft model (e.g., draft model 116) associated with a first number of parameters, and a fourth module includes a target model (e.g., target model 120) associated with a second number of parameters that is greater than the first number of parameters. For example, a third module may be a lighter model with fewer parameters than a fourth module such that a third module performs token generation faster than a fourth module (e.g., for the same number of tokens). In some embodiments, a draft module may include a text-to-text model (e.g., also referred to as a text-only model), and a target model may include a multimodal model (e.g., also referred to a vision language model). A text-to-text model may be a type of artificial intelligence model that receives natural language text as input and produces natural language text as output. A multimodal model may be a type of artificial intelligence model that may receive inputs of multiple modalities (e.g., text inputs, visual inputs, audio inputs, tactile inputs, or spatial inputs). A multimodal model may provide unimodal outputs or multimodal outputs. For example, a multimodal model may receive image and text data but may only have the capability to output text data. In another example, a multimodal model may receive image and text data and have the capability to output both image and text data.

In some embodiments, a fourth module, for a plurality of multimodal inputs, may generate a plurality of respective outputs of a first modality. Each of a plurality of multimodal inputs may include a respective first input of a first modality and a respective second input of a second modality. A third module may be trained to generate tokens of the first modality based on a plurality of respective outputs generated by the fourth module. As previously described in connection with FIGS. 3, 6A, 6B, and 6C, a draft model may be trained based on outputs of a target model. For example, draft model 218 may be trained by at least partially using target output 304 as testing data. In another example, a draft model may be trained based on outputs of a target model, where a target model generates outputs based on multimodal inputs (e.g., as previously described in step 622). In some embodiments, such as those described in connection with FIG. 6, a draft model may only receive tokens of a text modality, but such a draft model may also be trained on responses of a multimodal target model. As a result, a draft model may implicitly learn how to account for visual data by attempting to replicate responses of a multimodal target model.

In some embodiments, a third module may be associated with a first vocabulary (e.g., a draft vocabulary), a fourth module may be associated with a second vocabulary (e.g., a target vocabulary), and a third module may be trained based at least in part on an unmatched vocabulary representing a difference between a second vocabulary and a first vocabulary. For example, as previously described in connection with FIG. 5, one or more operations related to vocabulary expansion may be applied to a vocabulary associated with a draft model. As such, a draft model may increase its token acceptance rate and therefore achieve more practical speed ups during inference.

It will be understood that some embodiments provided in connection with FIGS. 1-7 may be at least partially implemented using any of the hardware and/or firmware provided below (e.g., in connection with FIGS. 8-10, as further described below).

FIG. 8 shows a block diagram illustrating an example compute accelerator, in accordance with some embodiments of the present disclosure, such as deep learning accelerator (DLA) 820. In some embodiments, DLA 820 includes I/O circuitry (e.g., field programmable gate arrays) 821 and PEs 822, enabled to communicate with each other, as illustrated by coupling 823. In some embodiments, processing circuitry, as referred to herein, may include DLA 820. As such, any component described herein may be implemented by one or more instances of DLA 820. For example, one or more instances of DLA 820 may be used to implement functionality of any one or more of encoder 108, projector 110, draft model 116, or target model 120. In another example, one or more instances of DLA 820 may be used to implement functionality of any one or more of a first module, a second module, a third module, or a fourth module (e.g., as previously described in connection with FIG. 8).

In some embodiments, one or more servers, user devices, and/or other systems may be communicatively coupled to DLA 820. DLA 820 is enabled to perform processing (e.g., training and/or inference) with neural networks, such as by computing weights in response to placement information and training information. DLA 820 is further enabled to provide the weights as results via one or more communication paths. PEs 822 comprise a relatively large number of PEs (e.g., 10,000 or more) each enabled to independently perform routing and computations relating to training. In some embodiments and/or usage scenarios, PEs 822 is implemented via wafer-scale integration, such as respective pluralities of PEs implemented on respective dice of a single wafer. I/O circuitry 821 are enabled to interface PEs 822 to information provided via one or more communication paths. The interfacing includes conversion to/from a first data structure (e.g., modified Ethernet frames or network packets) from/to a second data structure (e.g., fabric packets or wavelets), as communicated on Coupling 823. In various embodiments and/or usage scenarios, an example of processing the information comprises quantizing model weights or other values (e.g., converting from a floating-point number format to a fixed-point number format, encoding numerical values, or decoding values in a block numeric format).

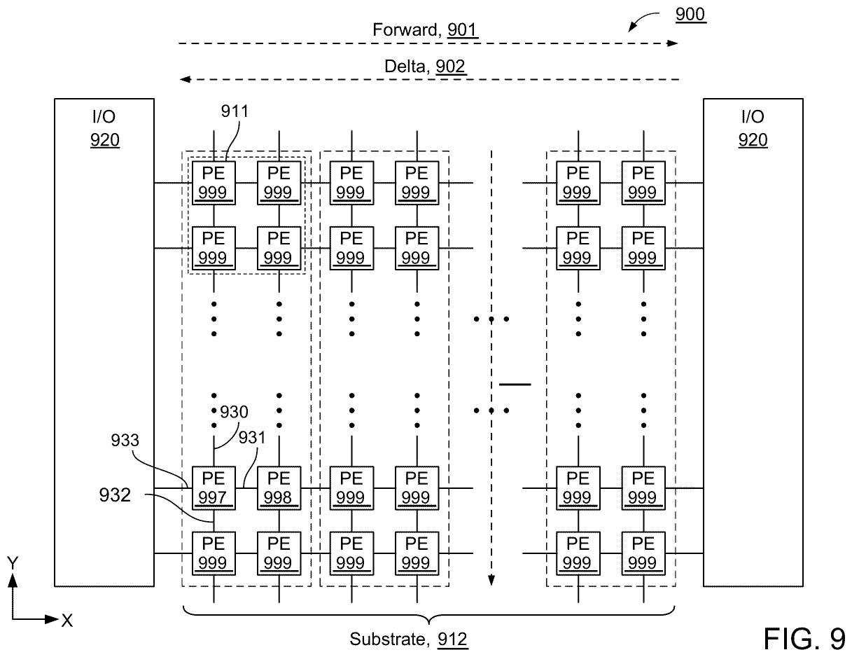

FIG. 9 depicts an example configuration of compute accelerator 900 including a plurality of processing elements 999 disposed at a single substrate 912, in accordance with some embodiments of this disclosure. It will be understood that compute accelerator 900 may be an example of DLA 820. That is, while compute accelerator 900 is shown to be different from DLA 820, it will be understood that such elements may amount to the same element or otherwise include at least some of the same elements as each other. Each of PE 999 elements has couplings to other of PE 999 elements. For example, two of the PE elements (PE 997 and PE 998) are illustrated with unique identifiers and are otherwise respectively identical to instances of PE 999. PE 997 is illustrated with identifiers for each of four couplings (North coupling 930, East coupling 931 with PE 998, and South coupling 932) to others of the PEs and one of the interface elements, such as I/O 920 (e.g., via West coupling 933), but is otherwise identical to others of the PE elements. In some embodiments, the couplings are logical and/or physical. In some embodiments, the couplings are to communicate data packets, backpressure information, or both. In some embodiments, all or any portions of the physical couplings are to physically adjacent PEs. In some embodiments and/or usage scenarios, the PEs are physically implemented in a 2D grid layout. For example, the PEs may be physically implemented in a 2D grid layout of aligned rectangles, and physically adjacent PEs correspond to PEs sharing a horizontal boundary (North/South PEs with respect to each other) and PEs sharing a vertical boundary (East/West PEs with respect to each other). In some embodiments, any of the PEs 999 include one or more of a different amount of memory, differing coupling technology, different power consumption, different operating frequency, etc.

In some embodiments, any one or more of the couplings between PEs may include a plurality of high-speed serial couplings (e.g., SerDes couplings, sometimes referred to as SERDES techniques).

In some embodiments, an array of ASICs is formed on a substrate (e.g., the substrate 912), and each of the ASICs comprises a plurality of PEs (e.g., PE 999). In some embodiments, one or more peripheral portions of the PEs are coupled to I/O 920. For example, a first ASIC may include a column-organized section of PEs, and a second ASIC may include a square-organized section or a rectangular-organized section of PEs. Other organizations of ASICs on the substrate 912 are included herein.

In some embodiments, model layers (e.g., network nodes associated with layers in a neural network) may be assigned to PE 999 elements in a left-to-right and/or an upper-to-lower fashion, with earlier layers (e.g., an input layer) on the left and/or upper ends and subsequent layers (e.g., an output layer) on the right and/or lower ends. Accordingly, data flow may be arranged between adjacent processing regions to follow a processing sequence such as a sequence of model layers.

In some embodiments, determining one or more processing regions include scaling (e.g., up or down) compute capacity and storage capacity in tandem, enabling various price/performance implementations. For example, 700 PEs may be allocated for a processing region along the X direction, and 700 PEs may be allocated for the processing region along the Y direction, with 490,000 PEs overall allocated to the processing region. For example, 1750 PEs may be allocated for a processing region along the X direction, and 1800 PEs may be allocated for the processing region along the Y direction, with 3,150,000 PEs overall allocated to the processing region.

In some embodiments, the substrate 912 comprises any one or more of a rack-width substrate, an entire wafer, a substantial portion of a wafer, a single ASIC, a plurality of ASICs, a plurality of dice, a plurality of 3D-stacked dice, and a PCB comprising one or more of the foregoing. For a first example, the substrate 912 may comprise a portion of a wafer corresponding to a largest rectangle, according to physical granularity of the PEs, fitting inside an entire substantially circular wafer. For a second example, the substrate 912 comprises N-by-M ASICs coupled via a PCB, each ASIC comprising A-by-B PEs. In this second example, the substrate may include N times A times M times B number of PEs.

In some embodiments, compute accelerator 900 may include an array of processing regions including one or more PEs and/or one or more memories (e.g., high-bandwidth memory (HBM) or other types of memory). In some embodiments, a processing region may include any type of memory (e.g., DRAM, SRAM, etc.) arranged proximately to the compute elements. In some embodiments, some formats of data packets communicated via the couplings between PEs 999 may include a packet payload, an indicator, and/or an instruction. In some embodiments, a plurality of PEs may be arranged as a PE cluster, each PE cluster including at least one memory (e.g., a memory stack, high-bandwidth memory, DRAM, etc.). A PE cluster may include any one or more of an entire wafer, a portion of a wafer, a single ASIC, a plurality of ASICs, a plurality of dice, a plurality of 3D-stacked dice, a plurality of 2.5D-stacked dice, and a PCB comprising one or more of the foregoing.

In some embodiments, data packets are communicated relatively more in parallel between PEs of a PE cluster than between PE clusters. For example, the couplings between PE 999 elements may enable communication of an entire data packet in a single clock cycle via a parallel transfer of a plurality of bits on a plurality of physical wires. For example, the couplings between the PE clusters may enable communication of a data packet over a plurality of clock cycles via a serial transfer of the bits of the data packet. In some embodiments, the clock for the parallel transfer and the clock for the serial transfer are multiples of each other so that bandwidth of the parallel transfer and the serial transfer are substantially identical, or alternatively an integer multiple of one another.

In some embodiments, a PE cluster includes memory implemented with one or more memory dies (e.g., DRAM dies) and/or a memory controller die. The PE cluster may be stacked by 3D-stacking the PE dies, the memory dies, and/or the memory controller die. In some embodiments, a PE cluster may be stacked by 2.5D-stacking the PE dies, the memory dies, and/or the memory controller die to an interposer. In some embodiments, memory dies may include storage via dynamic storage cells.

In some embodiments, local memory (e.g., 48 KB) of each PE may be used to store instructions and data, such as parameters and activations. The instructions and/or data are paged in and out of the local memory of each PE from and to the non-local memory under control of software executing on the respective PE, thus using the local memories as software managed caches for the PEs.

In some embodiments, PEs of the compute accelerator 900 are conceptually partitioned into compute, storage, and/or delivery roles by configuring and/or programming such that a fraction of the PEs substantially or entirely perform computation tasks and the remainder of the PEs substantially or entirely perform storage tasks (e.g., operand storage) and/or perform data delivery tasks.

In FIG. 9, a compute accelerator may include a plurality of PEs coupled to each other via a fabric. Each PE may include at least one compute element (CE) (e.g., for performing computations), local memory, and/or a router (e.g., for managing and/or implementing movement of information on the fabric).

The fabric operates as a communication interconnect between most or all of the PEs in the compute accelerator(s). The fabric transfers data packets, e.g., via physical couplings, to enable transfer of an entire data packet per cycle (e.g., core clock cycle). In some aspects, the fabric may be a local interconnect distributed throughput the PEs such that each PE is enabled to communicate directly with its (physical) neighbors. Communication to other-than (physical) neighbors is via hops through intermediate nodes, e.g., others of the PEs. In some embodiments, a distributed local fabric topology efficiently maps to a model (e.g., neural network) workload (e.g., each layer sends data to a neighboring layer) and/or is implementable with relatively lower cost in hardware.

For example, at FIG. 9, a (physical) fabric topology may include a 2D mesh with each hop in the X or Y dimension performed in a single core clock cycle. In some embodiments, a PE may include skip connections and/or loop connections. In some embodiments, an example skip connection enables PEs in a same row of the 2D mesh and physically separated by a number of other PEs to communicate with each other as if the PEs were physically adjacent. For example, a hop along a skip connection is performed in a single core clock cycle. In some embodiments, an example loop connection enables a PE at the bottom of a column of PEs to communicate with a PE at the top of the column as if the PEs were physically adjacent. In some embodiments, a hop along a loop connection is performed in a single core clock cycle.

In some embodiments, performing each hop in the X or Y dimension in a single clock enables simplifying implementation of arbitrary programmable routing topologies and related timing constraints. In some circumstances, the single cycle per hop latency is compatible with an associated pipelined data flow pattern. In some circumstances (e.g., when communicating from one layer to a next layer), the single cycle per hop latency adds additional latency and reduces performance. The additional latency is worse when the layer is deep and uses many PEs, since more hops are used to escape the layer and to reach all the PEs of the next layer. The additional latency results in overall workload pipeline length increasing and therefore storage (e.g. for forward pass activations) increasing.

The skip connections may be used to reduce the additional latency. For example, each skip connection may skip 50 PEs in a single core clock cycle. The latency to enter the first skip connection is 49 hops maximum. The latency to reach a final PE after exiting a final skip connection is 49 hops maximum. Then, there is a 98-core clock cycle maximum latency overhead and a 49-core clock cycle average latency overhead. The latency to process a layer is 2000 core clock cycles. In this example, there is a 5% maximum overall overhead and a 2.5% average overall overhead.

In some embodiments, each row has skip connections and each column has loop connections. In some embodiments, each skip connection skips 50 PEs, and each column has 200 PEs that a loop connection encompasses. In some embodiments, a single loop connection (e.g., in a context of a column of PEs, between the PE at the bottom of the column and the PE at the top of the column) approximately physically spans the column, and in other embodiments, loop connections of the column are physically implemented by folding so that the average and worst case loop hops approximately physically span two PEs.

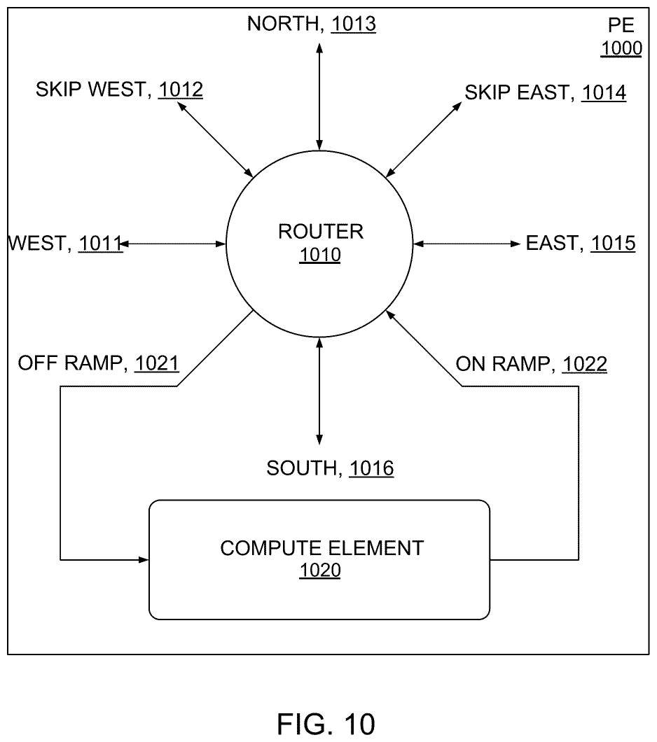

FIG. 10 shows a block diagram illustrating an example PE as PE 1000 of a compute accelerator, in accordance with some embodiments of the present disclosure. It will be understood that PE 1000 may be an element of at least one of DLA 820 or compute accelerator 900. For example, DLA 820 and compute accelerator 900 may include a plurality of instances of PE 1000. In some embodiments, PE 1000 includes Router 1010 and Compute Element 1020. Router 1010 selectively and/or conditionally communicates (e.g. transmits and receives) data packets between other PEs (e.g., logically adjacent and/or physically adjacent PEs) and PE 1000 via couplings 1011-1016. Couplings 1011-1216 are illustrated as bidirectional arrows to emphasize the bidirectional communication of data packets on the couplings. Backpressure information is also transmitted on the couplings in the reverse direction of packet information the backpressure corresponds to. Router 1010 selectively and/or conditionally communicates data packets to PE 1000 (e.g., Compute Element 1020) via Off Ramp 1021 and communicates data packets from PE 1000 (e.g., Compute Element 1020) via On Ramp 1022. Off Ramp 1021 is illustrated as a unidirectional arrow to emphasize the unidirectional communication of data packets on the coupling (e.g., from Router 1010 to Compute Element 1020). Backpressure information is also transmitted on the coupling in the reverse direction of packet information (e.g. from Compute Element 1020 to Router 1010). On Ramp 1022 is illustrated as a unidirectional arrow to emphasize the unidirectional communication of data packets on the coupling (e.g., from Compute Element 1020 to Router 1010). Backpressure information is also transmitted on the coupling in the reverse direction of packet information (e.g. from Router 1010 to Compute Element 1020).

Compute Element 1020 performs computations on data embodied in the data packets according to instruction address information derivable from the data packets. The instruction address information is used to identify starting addresses of tasks embodied as instructions stored in storage (e.g., any one or more of memory, cache, and register file(s)) of the compute element. Results of the computations are selectively and/or conditionally stored in the storage and/or provided as data embodied in data packets communicated to the router for, e.g., transmission to the other PEs and or PE 1000.

In addition to data, Router 1010 selectively and/or conditionally communicates (e.g. transmits and receives) backpressure information between the other PEs and PE 1000 via couplings 1011-1016. Router 1010 selectively and/or conditionally transmits backpressure information to PE 1000 via On Ramp 1022. Router 1010 receives backpressure information from PE 1000 via Off Ramp 1021. The backpressure information provided to the other PEs, as well as the backpressure information provided to PE 1000, is used by the other PEs and PE 1000 to stall transmitting data (e.g., packets) that would otherwise be lost due to insufficient queue space to store the data in Router 1010. The backpressure information received from the other PEs and PE 1000 is used respectively by Router 1010 to prevent transmitting data (e.g., packets) that would otherwise be lost due respectively to insufficient queue space in the routers of the other PEs and insufficient space in input queues of Compute Element 1020.

In various embodiments, any one or more of 1011-1016 are omitted.

In some embodiments and/or usage scenarios, PE 1000 is an embodiment of PE 999 of compute accelerator 900, and/or elements of PE 1000 correspond to an implementation of PE 999. In some embodiments and/or usage scenarios, North 1013, East 1015, South 1016, and West 1011 correspond respectively to North coupling 930, East coupling 931, South coupling 932, and West coupling 933 of compute accelerator 900.

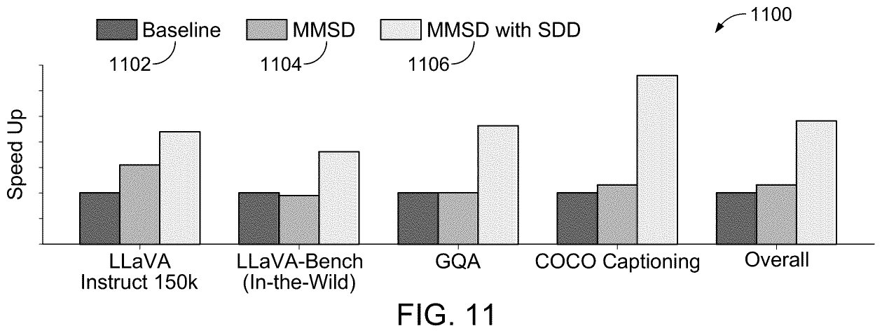

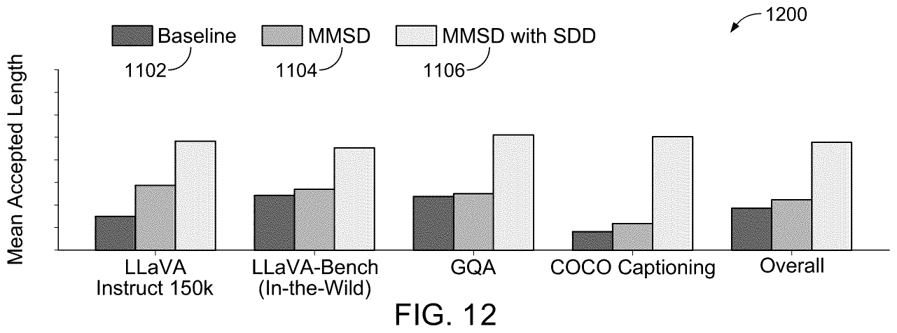

FIGS. 11-12 are illustrative examples of practical results that may be achieved based on some embodiments disclosed herein, in accordance with some embodiments of the present disclosure. Further description of such results is provided in the following paragraphs.

FIG. 11 includes graph 1100 which shows end-to-end wall clock speed ups that may be achieved on various benchmark datasets such as Large Language and Vision Assistant (LLaVA)-Instruct, LLaVA-Bench, Graph Question Answer (GQA) and Common Objects in Context (COCO) Captioning. In some embodiments, a baseline speed up may be shown by bars 1102, a speed up achieved with multimodal speculative decoding (MMSD) may be shown by bars 1104, and a speed up achieved with MMSD and self-data distillation (SDD) may be shown by bars 1106. In some embodiments, bars 1102 may be based on using Qwen 2.5-1.5B models as text-only drafters such that image tokens are not included as input in a multimodal scenario. In some embodiments, bars 1104 may be based on approaches as shown in FIG. 1 (e.g., where a unimodal draft model is used as a draft model). In some embodiments, bars 1106 may be based on approaches shown in FIGS. 4-5 (e.g., where unimodal draft models are trained based on responses of a multimodal draft model and such unimodal draft models are used for speculative decoding inference). In some embodiments, results provided by graph 1100 are based on a temperature value being set to 0 and a speculation length of 5.

FIG. 12 includes graph 1200 which shows average acceptance lengths. Similar to graph 1100, comparative results between a baseline, MMSD, and MMSD with SSD approach are provided. In some embodiments, temperature may be set to 0 and a speculation length may be set to 5. As shown in graph 1200, techniques provided by some embodiments disclosed herein provide improvements in token acceptance rates across various lengths, thereby increasing computational efficiency and allowing faster inference times for multimodal frameworks.

Any parameters described in the present disclosure may include any combination of scalars, vectors, matrices, tensors, and so forth, such as arrangements of an arbitrary number and an arbitrary complexity of elements. For example, the parameters are of various dimensions, such as one-dimensional, two-dimensional, three-dimensional, and otherwise multidimensional. For example, the parameters are of various datatypes, such as, integer and floating-point. For example, the parameters (or respective portions thereof, e.g., an exponent or a mantissa) are represented with various precisions (sometimes referred to as widths), such as, 8-bit, 16-bit, 32-bit, 64-bit, and so forth.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

An enumerated listing of items does not imply that any or all of the items are mutually exclusive, unless expressly specified otherwise.

The terms “a”, “an” and “the” mean “one or more”, unless expressly specified otherwise.

Devices, or components thereof, that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments. Further, although process steps, method steps, algorithms or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least particular operations that may have been illustrated in the figures show particular events occurring in a particular order. In some alternative embodiments, particular operations may be performed in a different order, modified, combined, or removed. Moreover, steps may be added to the above-described circuitry(ies) and conform to the described embodiments without departing from the principles set forth in the present disclosure. Some operations described herein may occur sequentially, and/or particular operations may be processed in parallel. Any operation may be performed by a single processor or by distributed processors.

The processes discussed above are intended to be illustrative and not limiting. One skilled in the art would appreciate that the steps of the processes discussed herein may be omitted, modified, combined and/or rearranged, and any additional steps may be performed without departing from the scope of the present disclosure.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations thereto and modifications thereof, which are within the spirit of the following claims.

What is claimed is:

1. A method comprising:
receiving an input comprising first data of a first modality and second data of a second modality;
generating, using a first module, a first one or more tokens associated with the first modality based on the second data, wherein the first module is trained to map embeddings of the second modality to embeddings of the first modality;
generating, using a second module, a second one or more tokens associated with the first modality based on the first data;
generating, using a third module, one or more speculative tokens based on (a) the first one or more tokens associated with the first modality generated by the first module and (b) the second one or more tokens associated with the first modality generated by the second module; and
performing, using a fourth module, speculative decoding inference based on the one or more speculative tokens.

2. The method of claim 1, wherein:
the first modality comprises a text type; and
the second modality comprises an image type.

3. The method of claim 1, wherein:
the first module comprises a multimodal projector;
the second module comprises a text tokenizer;
the third module comprises a draft model associated with a first number of parameters; and
the fourth module comprises a target model associated with a second number of parameters that is greater than the first number of parameters.

4. The method of claim 3, wherein:
the draft model comprises a text-to-text model; and
the target model comprises a multimodal model.

5. The method of claim 1, wherein:
the fourth module, for a plurality of multimodal inputs, generates a plurality of respective outputs of the first modality;
each of the plurality of multimodal inputs comprises a respective first input of the first modality and a respective second input of the second modality; and
the third module is trained to generate tokens of the first modality based on the plurality of respective outputs generated by the fourth module.

6. The method of claim 1, wherein:
the third module is associated with a first vocabulary;
the fourth module is associated with a second vocabulary; and
the third module is trained based at least in part on an unmatched vocabulary representing a difference between the second vocabulary and the first vocabulary.

7. The method of claim 1, wherein:
a fifth module determines an unmatched vocabulary representing a difference between a first vocabulary of the third module and a second vocabulary of the fourth module;
the fifth module determines embeddings for the unmatched vocabulary based on a mean of an existing vocabulary and a covariance of the existing vocabulary; and
the third module generates the one or more speculative tokens based at least in part on the embeddings.

8. The method of claim 1, wherein the one or more speculative tokens comprise reasoning tokens and non-reasoning tokens.

9. The method of claim 1, wherein the first module is trained based on constant parameters of a fifth module and constant parameters of the third module, wherein the fifth module comprises a target vision encoder and the third module comprises a draft model for the fourth module.

10. The method of claim 1, wherein performing the speculative decoding inference comprises verifying, using the fourth module, the one or more speculative tokens generated by the third module.

11. A system comprising circuitry configured as a plurality of processing elements (PEs), wherein the circuitry is configured to:
receive an input comprising first data of a first modality and second data of a second modality;
generate, using a first module, a first one or more tokens associated with the first modality based on the second data, wherein the first module is trained to map embeddings of the second modality to embeddings of the first modality;
generate, using a second module, a second one or more tokens associated with the first modality based on the first data;
generate, using a third module, one or more speculative tokens based on (a) the first one or more tokens associated with the first modality generated by the first module and (b) the second one or more tokens associated with the first modality generated by the second module; and
perform, using a fourth module, speculative decoding inference based on the one or more speculative tokens.

12. The system of claim 11, wherein:
the first modality comprises a text type; and
the second modality comprises an image type.

13. The system of claim 11, wherein:
the first module comprises a multimodal projector;
the second module comprises a text tokenizer;
the third module comprises a draft model associated with a first number of parameters; and
the fourth module comprises a target model associated with a second number of parameters that is greater than the first number of parameters.

14. The system of claim 13, wherein:
the draft model comprises a text-to-text model; and
the target model comprises a multimodal model.

15. The system of claim 11, wherein:
the fourth module, for a plurality of multimodal inputs, generates a plurality of respective outputs of the first modality;
each of the plurality of multimodal inputs comprises a respective first input of the first modality and a respective second input of the second modality; and
the third module is trained to generate tokens of the first modality based on the plurality of respective outputs generated by the fourth module.

16. The system of claim 11, wherein:
the third module is associated with a first vocabulary;
the fourth module is associated with a second vocabulary; and
the third module is trained based at least in part on an unmatched vocabulary representing a difference between the second vocabulary and the first vocabulary.

17. The system of claim 11, wherein:
a fifth module determines an unmatched vocabulary representing a difference between a first vocabulary of the third module and a second vocabulary of the fourth module;
the fifth module determines embeddings for the unmatched vocabulary based on a mean of an existing vocabulary and a covariance of the existing vocabulary; and
the third module generates the one or more speculative tokens based at least in part on the embeddings.

18. The system of claim 11, wherein the one or more speculative tokens comprise reasoning tokens and non-reasoning tokens.

19. The system of claim 11, wherein the first module is trained based on constant parameters of a fifth module and constant parameters of the third module, wherein the fifth module comprises a target vision encoder and the third module comprises a draft model for the fourth module.

20. The system of claim 11, wherein performing the speculative decoding inference comprises verifying, using the fourth module, the one or more speculative tokens generated by the third module.
